(19) United States
(12) Patent Application Publication
(10) Pub. No.: US 2009/0089037 A1
(43) Pub. Date: Apr. 2, 2009

(54) Method and apparatus for circuit simulation in view of stress exerted on MOS transistor

(75) Inventor: Kenta Yamada, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/285,215

(22) Filed: Sep. 30, 2008

(30) Foreign Application Priority Data
Oct. 1, 2007 (JP) 2007-258117

(51) Int. Cl. G06F 17/50

(52) U.S. Cl. 703/14

(57) ABSTRACT

A circuit simulation method includes: generating graphical data indicating dimensions of a subject MOS transistor; calculating a parameter correction amount based on said graphical data; correcting a given transistor model parameter in response to said parameter correction amount; and performing circuit simulation of a circuit that includes said subject MOS transistor by using said corrected transistor model parameter. The parameter correction amount is calculated based on said graphical data by using arithmetic equations. The arithmetic equations include at least one stress model equation expressing a stress exerted on a channel region of a model MOS transistor. The stress model equation is suitably defined to simulate the stress exerted on the channel region.

### INCORPORATION BY REFERENCE

This application claims the benefit of priority based on Japanese Patent Application No. 2007-258117, filed on Oct. 1, 2007, the disclosure of which is incorporated herein by reference.

### BACKGROUND OF THE INVENTION

1. Field of the Invention

The present invention relates to a method and apparatus for circuit simulation, more particularly, to circuit simulation based on stress exerted on MOS transistors.

2. Description of the Related Art

Circuit simulation is one of the important techniques in the development of semiconductor integrated circuits. An operation of a designed semiconductor integrated circuit is checked by circuit simulation to confirm whether the subject semiconductor integrated circuit satisfies design specifications. This allows developing semiconductor integrated circuits with desired functions and performances.

A typical procedure of circuit simulation is as follows: First, characteristics of respective MOS transistors with different layout dimensions (e.g. gate length L, gate width W and the like) are measured. Next, measurement data obtained by the measurement are used to extract transistor model parameters which represent characteristics of MOS transistors, and the transistor model parameters are used for circuit simulation. SPICE (Simulation Program with Integrated Circuit Emphasis) is the de facto standard technique used for circuit simulation. For circuit simulation based on SPICE, transistor model parameters defined by a transistor model in accordance with the SPICE format (e.g. BSIM3 (Berkley Short Channel IGFET Model 3) or BSIM4) are extracted. Accuracy improvement of circuit simulation is important to appropriately verify an operation of the semiconductor integrated circuit.

In recent years, increasing attention has been paid to effects of the stress exerted on an MOS transistor, which is one of the causes which reduce circuit simulation accuracy. The effects of the stress exerted on the MOS transistor, especially variations in the channel mobility and threshold voltage, have been enhanced due to the enhanced integration degree of the semiconductor integrated circuit. It is therefore desirable that effects of the stress exerted on MOS transistors are considered in circuit simulation of a semiconductor integrated circuit with high integration degree.

Japanese Laid-Open Patent Application No. P2004-86546A (hereinafter, referred to as the '546 application) discloses a technique to perform circuit simulation taking into account the stress exerted on MOS transistors. In the disclosed technique, circuit simulation is schematically carried out in accordance with the following procedure (See paragraphs [0050] to [0052]). First, model parameters are extracted for various values of the stress exerted on MOS transistors. A most appropriate model parameter set is then selected out of the plurality of the model parameter sets depending on the transistor dimensions. The selected model parameter set is used in circuit simulation. The '546 application discloses that the stress generated by an isolation dielectric largely influences on characteristics of a MOS transistor (See paragraphs [0038] and [0039]). Parameters used as the index of the stress strength include widths of an isolation dielectric in the gate-length direction and the gate-width direction (refer to the paragraph [0080]).

Japanese Laid Open Patent Application No. P2006-178907A also discloses a technique in which the distances from a certain active region to the adjacent active regions in the gate-width direction are used as index parameters of the stress exerted on the MOS transistor. The technique disclosed in this application uses an approximate correction equation to correct transistor model parameters, the approximate correction equation being based on the distance to the adjacent active regions in the gate-width direction.

Japanese Laid-Open Patent Application No. P2004-327463A further discloses a technique which calculates the stress applied to the channel region by using a model equation from the length and width of the active region, calculates the carrier mobility from the calculated stress, and then calculates the drain current from the carrier mobility.

According to the study of the inventor, the above-described techniques, which does not appropriately take into account the stress exerted on the channel region of the MOS transistor, does not achieve highly-accurate circuit simulation

### SUMMARY

In one aspect of the present invention, a circuit simulation method includes: generating graphical data indicating dimensions of a subject MOS transistor; calculating a parameter correction amount on the basis of the graphical data; correcting a given transistor model parameter in response to the parameter correction amount; and performing circuit simulation of a circuit that includes the subject MOS transistor by using the corrected transistor model parameter. The parameter correction amount is calculated based on the graphical data by using arithmetic equations. The arithmetic equations include a stress model equation expressing a stress exerted on a channel region of a model MOS transistor. The stress model equation is defined so that a magnitude of the stress monotonously decreases with an increase in an adjacent distance from an active region within which the channel region of the model MOS transistor is formed to an active region adjacent thereto, and converges to a constant value when the adjacent distance is infinitely large, and so that an absolute value of a differential coefficient of the stress with respect to the adjacent distance monotonously decreases with an increase in the adjacent distance, and converges to zero when the adjacent distance is infinitely large.

In another aspect of the present invention, a circuit simulation apparatus is provided with a tool which generates graphical data indicating dimensions of a subject MOS transistor and calculates a parameter correction amount based on the graphical data; and a circuit simulator which corrects a given transistor model parameter in response to the parameter correction amount, and performs circuit simulation of a circuit that includes the subject MOS transistor by using the corrected transistor model parameter. The parameter correction amount is calculated based on the graphical data by using arithmetic equations. The arithmetic equations include at least one stress model equation expressing a stress exerted on a channel region of a model MOS transistor. The stress model equation is defined so that a magnitude of the stress monotonously decreases with an increase in an adjacent distance from an active region within which the channel region of the model MOS transistor is formed to an active region adjacent thereto, and converges to a constant value when the adjacent distance is infinitely large, and so that an absolute value of a differential coefficient of the stress with respect to the adjacent distance monotonously decreases with an increase in the adjacent distance, and converges to zero when the adjacent distance is infinitely large.

In still another aspect of the present invention, a computer-readable recording medium which records a program that when executed controls a computer to perform a method comprising: generating graphical data indicating dimensions of a subject MOS transistor; calculating a parameter correction amount on the basis of the graphical data, correcting a given transistor model parameter in response to the parameter correction amount; and performing circuit simulation of a circuit that includes the subject MOS transistor by using the corrected transistor model parameter. The parameter correction amount is calculated based on the graphical data by using arithmetic equations. The arithmetic equations include a stress model equation expressing a stress exerted on a channel region of a model MOS transistor. The stress model equation is defined so that a magnitude of the stress monotonously decreases with an increase in an adjacent distance from an active region within which the channel region of the model MOS transistor is formed to an active region adjacent thereto, and converges to a constant value when the adjacent distance is infinitely large, and so that an absolute value of a differential coefficient of the stress with respect to the adjacent distance monotonously decreases with an increase in the adjacent distance, and converges to zero when the adjacent distance is infinitely large.

The present invention realizes highly accurate circuit simulation, appropriately taking into account the stress exerted on the channel region of MOS transistor.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a plan view showing an exemplary layout pattern of an MOS transistor subjected to circuit simulation in one embodiment of the present invention;

FIG. 2 is a block diagram showing an exemplary implementation of a circuit simulation technique in one embodiment of the present invention;

FIG. 3 is a functional block diagram illustrating functions of an LVS tool in the circuit simulation technique in one embodiment of the present invention;

FIG. 4 is a plan view showing a basic pattern of the MOS transistor;

FIG. 5A is a plan view showing an element structure used to obtain a one-dimensional model equation;

FIG. 5B is a cross-sectional view showing the element structure used to obtain the one-dimensional model equation;

FIG. 6A is a graph showing the relation of the stress oh exerted on an subject active region of interest in the in-plane direction of a substrate with the distance Sd from the adjacent active region and the width Wd of the active region;

FIG. 6B is a graph showing the relation of the stress av exerted on the subject active region in the vertical direction of the substrate with the distance Sd from the adjacent active region and the width Wd of the subject active region;

FIG. 7 is a flowchart showing an exemplary procedure for extracting stress model parameters and sensitivity parameters in one embodiment;

FIG. 8 is a flowchart showing an exemplary procedure for calculating parameter correction amounts for an MOS transistor in a general layout pattern;

FIG. 9 is a plan view showing an example of division of a channel region; and

FIG. 10 is a plan view showing an example of graphic data extracted for respective channel portions.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### 1. Outline of Circuit Simulation

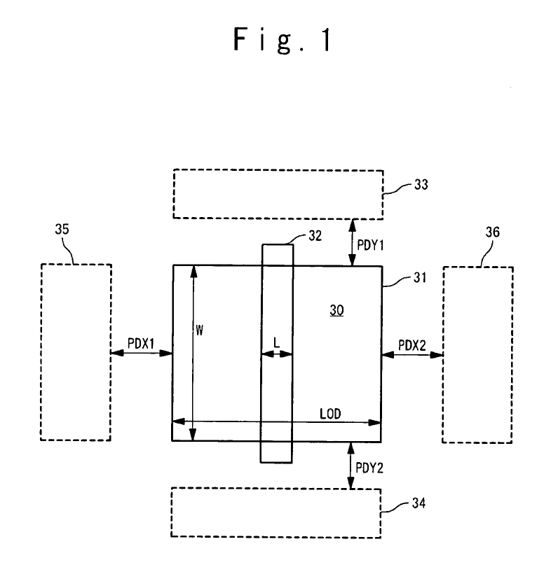

Referring to FIG. 1, a description is first given of an outline of circuit simulation in one embodiment of the present invention.

FIG. 1 shows an exemplary layout of an MOS transistor. In FIG. 1, the reference numeral 30 denotes an MOS transistor to be subjected to circuit simulation. The reference numeral 31 denotes an active region of the MOS transistor 30 and the reference numeral 32 denotes the gate of the MOS transistor 30. The gate 32 is provided so as to cross the active region 31. The active region 31 includes a portion which functions as a channel region of the MOS transistor 30, disposed just beneath the gate 32. Active regions 33 to 36 are provided around the active region 31. The active regions 33 and 34 are disposed adjacent to the active region 31 in the gate-width direction, while the active regions 35 and 36 are disposed adjacent to the active region 31 in a gate-length direction. The active region 31 is separated from the active regions 33 to 36 by an STI (Shallow Trench Isolation) dielectric film. In FIG. 1, the symbol L indicates the gate length of the MOS transistor 30, the symbol W indicates the gate width of the MOS transistor, and the symbol LOD indicates the length of the active region 31 in the gate-length direction. The symbols PDX1 and PDX2 indicate distances from the active region 31 to adjacent active regions (i.e. active regions 35 and 36) in the gate-length direction, respectively, and the symbols PDY1 and PDY2 indicate distances from the active region 31 to adjacent active regions (i.e. active regions 33 and 34) in the gate-width direction, respectively.

Schematically, the circuit simulation technique in this embodiment is as follows: First, a parameter correction amount is calculated based on layout dimensions (i.e. L, W, LOD, PDX1, PDX2, PDY1 and PDY2) of each MOS transistor. It should be noted that a parameter correction amount refers to a value indicative of a correction amount in correcting a transistor model parameter used in the circuit simulation. Arithmetic equations used in calculation of parameter correction amounts include stress model equations which express the stress exerted on the active region in the MOS transistor, so that the parameter correction amounts are calculated depending on the stress exerted on the active region. Transistor model parameters are corrected in accordance with the calculated parameter correction amounts, and the corrected transistor model parameters are used to perform circuit simulation.

As an example, a detailed explanation will be given for a case where transistor model parameters U0 and VTH0 of a transistor model for use in the SPICE are corrected depending on the stress. As known in the art, U0 is a parameter corresponding to mobility in the channel regions and VTH0 is a parameter corresponding to a threshold voltage in the MOS transistor. In this case, parameter correction amounts may be correction amounts Δμ and Δν or values one-to-one associated with the correction amounts Δμ and Δν; Δμ and Δν are numerical values defined as follows:

Δμ=μ−U0,

Δν=ν−VTH0,

where μ and ν are corrected values of the transistor model parameters U0 and VTH0, respectively. It should b noted that “U0” and “VTH0” are merely transistor model parameters which may be different from mobility in the channel region and the threshold voltage of the MOS transistor as obtained by measurement. In order to avoid confusion with the mobility in the channel region and threshold voltage Vt, which are characteristics values of an actual transistor, “U0”, which is one of the transistor model parameters, is referred to as μ0, while “VTH0”, which is another one of the transistor model parameters, is referred to as ν0, in the present specification. In accordance with such expression, the correction amounts Δμ and Δν are defined as follows:

Δμ=μ−μ0,

Δν=ν−ν0.

In this embodiment, a parameter correction amount MULU0 defined by the following equation is used as a value indicative of the correction amount for the transistor model parameter μ0 (U0) in place of the parameter correction amount Δμ:

MULU0=1+Δμ/μ0.

In addition, a parameter correction amount DELVT0 is defined as identical to the correction amount Δν for the transistor model parameter ν0 (VTH0). More specifically, it holds:

DELVT0=Δν.

The parameter correction amounts MULU0 and DELVT0 are fed to a SPICE simulator. The SPICE simulator corrects the transistor model parameters U0 and VTH0 in accordance with the parameter correction amounts MULU0 and DELVT0 and performs circuit simulation by using the corrected transistor model parameters.

In the following, an example of the circuit simulation technique of this present embodiment will be described in detail, in which the SPICE circuit simulation is carried out with the transistor model parameters U0 and VTH0 corrected depending on the stress. It should be noted that other transistor model parameters may be also corrected depending on the stress.

### 2. Circuit Simulation Implementation

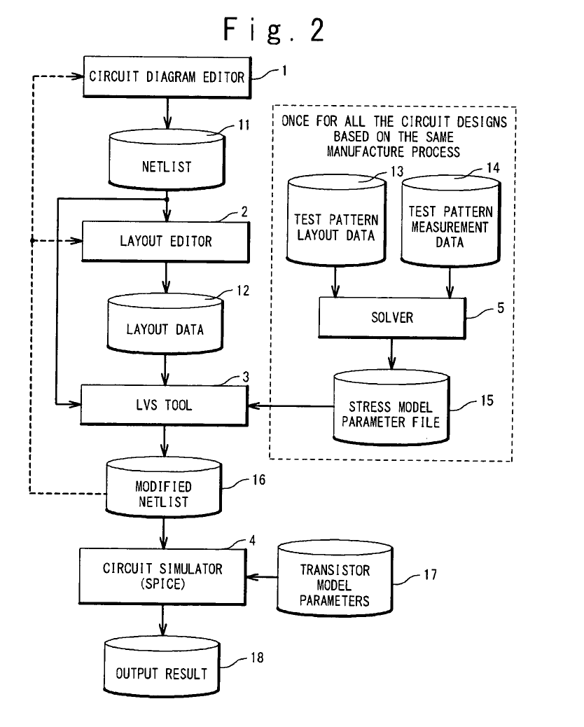

FIG. 2 shows an example of a mounting form in the circuit simulation technique according to the present embodiment. In the present embodiment, circuit design and simulation are implemented by a circuit diagram editor 1, a layout editor 2, a LVS (Layout Versus Schematic) tool 3, a circuit simulator 4, and a solver 5.

The circuit editor 1 is a software program used to generate a netlist 11. The netlist 11 generated by the circuit editor 1 is stored in a storage device (not shown) and fed to the layout editor 2. In this embodiment, the netlist 11 is generated in a format supported by the SPICE.

The layout editor 2 is a software program used to generate layout data 12 indicative of the layout of the circuit of interest from the netlist 11. The generated layout data 12 is stored in the storage device and fed to the LVS tool 3.

The LVS tool 3 checks whether a netlist extracted from the layout data 12 matches the netlist 11 generated by the circuit editor 1, and modifies the layout data 12 if necessary.

In this embodiment, the LVS tool 3 is also used to calculate parameter correction amounts for the respective MOS transistors within the circuit of interest from the layout data 12. The calculation of the parameter correction amounts is realized by describing necessary equations in a rule file of the LVS tool 3.

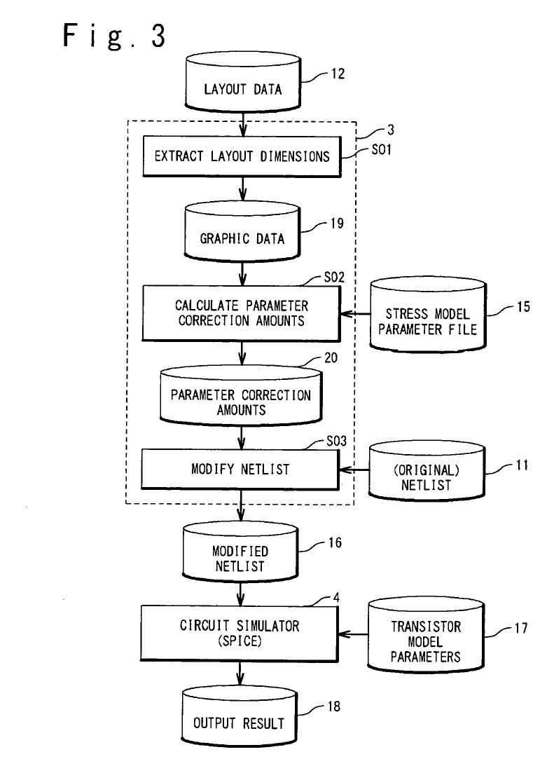

FIG. 3 is a function block diagram showing procedures for the LSV tool 3 to calculate the parameter correction amounts. The LVS tool 3 extracts layout dimensions (i.e. L, W, LOD, PDX1, PDX2, PDY1 and PDY2) of each MOS transistor from the layout data 12, and stores graphic data 19 describing the extracted layout dimensions in the storage device at Step S01.

The LVS tool 3 further calculates the parameter correction amounts from the layout dimensions described in the graphic data 19 at Step S02. In this embodiment, the parameter correction amounts MULU0 and DELVT0, which are equivalent to the parameter correction amounts Δμ and Δν, are calculated for the transistor model parameters U0 and VTH0. In FIG. 3, the calculated parameter correction amounts are collectively denoted by the reference numeral 20.

Arithmetic equations used in the calculation of the parameter correction amounts 20 include stress model equations which express the stress exerted on the active region of the MOS transistor, and functional equations used for calculating the parameter correction amounts. The stress model equations and functional equations are written in the rule file of the LVS tool 3. The stress model equations written in the rule file of the LVS tool 3 include undetermined parameters. These undetermined parameters are used to finally determine the properties of the stress model equation which is actually used in the circuit simulation, and referred to as “stress model parameters”, hereinafter. The functional equations used for calculating the parameter correction amounts also include undetermined parameters. These parameters represent degrees of contribution of the stress to the parameter correction amounts, and referred to as “sensitivity parameters”, hereinafter. It is of importance to appropriately determine the stress model parameters and sensitivity parameters to accurately calculate the stress exerted on the channel region in the MOS transistor, and further to precisely take into account the effects of the stress in calculating the parameter correction amounts. Details of the stress model parameters and the sensitivity parameters will be explained later.

A stress model parameter file 15 is referred in calculating the parameter correction amounts by using the stress model equations and the functional equations. Written in the stress model parameter file 15 are stress model parameters and sensitivity parameters extracted by the solver 5 in advance. The parameter correction amounts 20 are calculated by using the stress model equations and the functional equations, after the stress model equations and the functional equations to be actually applied are determined by the stress model parameters and the sensitivity parameters written in the stress model parameter file 15.

The LVS tool 3 further generates a corrected netlist 16 by adding the calculated parameter correction amounts 20 to the netlist 11 at Step S03. The corrected netlist 16 is stored in a storage device (not shown).

Referring to FIG. 2 again, the circuit simulator 4 is a software program which performs circuit simulation based on the modified netlist 16 generated by the LVS tool 3 and previously extracted transistor model parameters 17. The circuit simulator 4 corrects the transistor model parameters 17 in accordance with the parameter correction amounts 20 described in the modified netlist 16 so as to perform circuit simulation by using a modified transistor model parameter. The circuit simulation results are outputted as an output result 18. The SPICE is used as the circuit simulator 4 in this embodiment, and the transistor model parameters 17 are prepared in a format supported by the SPICE. As well known in the art, the transistor model parameters 17 is extracted from characteristics of specific MOS transistors. Layout patterns of the MOS transistors used to extract the transistor model parameters 17 are referred to as the “SPICE extract patterns”, hereinafter.

The solver 5 is a software program used to extract the aforementioned stress model parameters and sensitivity parameters. Schematically, the extraction of the stress model parameters and the sensitivity parameters is carried out as follows: First, MOS transistors with various layouts are prepared and the characteristics thereof are measured. The solver 5 are then fed with the following data: test pattern layout data 13 describing layout dimensions of the MOS transistors used to extract the stress model parameters, and test pattern measurement data 14 describing the measured characteristics of the MOS transistors. The solver 5 extracts the stress model parameters and the sensitivity parameters from the test pattern layout data 13 and the test pattern measurement data 14, and stores the extracted stress model parameters and sensitivity parameters in the stress model parameter file 15. Basically, it is sufficient that extraction of the stress model parameters and sensitivity parameters is carry out once for the same manufacture process. Detailed procedures to extract the stress model parameters and the sensitivity parameters will be explained later.

Some (including all) of the aforementioned circuit editor 1, the layout editor 2, the LVS tool 3, the circuit simulator 4 and the solver 5 may be installed in the same computer, or may be installed in different computers. Although the LVS tool 3 is used for calculating the parameter correction amounts in this embodiment, the circuit simulation technique of this embodiment may be implemented in various architectures. For example, a tool dedicated for calculating the parameter correction amounts may be used in place of the LVS tool 3.

In the following, a description is first given of the stress model equations, followed by a description of the arithmetic equations used to calculate the parameter correction amounts. A description of extraction of the stress model parameters and sensitivity parameters is then given. Finally, a procedure of calculating the parameter correction amounts for the respective MOS transistors will be described.

### 3. Stress Model Equation

One feature of the circuit simulation technique of this embodiment is related to stress model equations which are used to calculate the parameter correction amounts. According to the study of the inventor, the behavior of the stress exerted on the channel region of the MOS transistor is as follows:

The magnitude (or absolute value) of the stress exerted on the subject channel region increases with the decrease in the distance Sd to an adjacent active region. The magnitude of the stress converges to a constant value when the distance Sd to the adjacent active region is infinitely large, while the magnitude of the stress sharply increases with the decrease in the distances Sd. The dependence of the stress on the distance Sd differs depending on the width Wd of the active region in which the subject channel region is formed. The magnitude of the stress sharply increases with the decrease in the width Wd of the active region, whereas the magnitude of the stress converges to a constant value when the width Wd is infinitely large. The stress model equations in this embodiment are determined so as to express such behavior.

In this embodiment, the stress model equations includes an equation which expresses the stress exerted in an in-plane direction of the substrate, and an equation which expresses the stress exerted in the vertical direction of the substrate. According to the studies of the inventor, the characteristics of the channel region in the MOS transistor are considerably influenced by not only the stress exerted in the in-plane direction of the substrate but also the stress exerted in the vertical direction of the substrate. Highly accurate circuit simulation can be realized by the fact that the stress model equations include an equation which expresses the stress in the in-plane direction of the substrate, and an equation which expresses the stress in the vertical direction of the substrate.

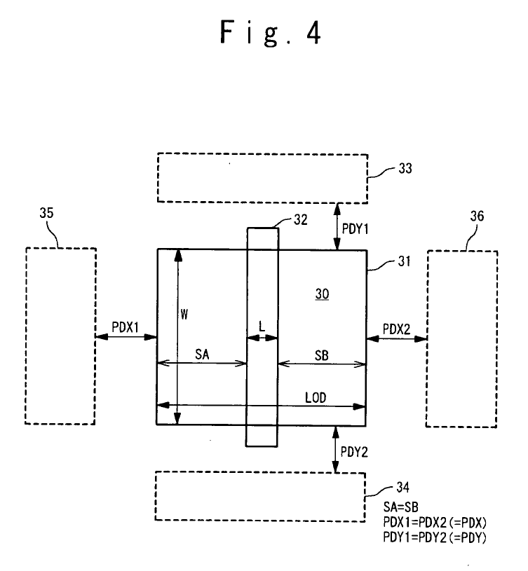

In the following a description is given of details of the stress model equations. In this embodiment, the stress model equations are defined so as to express the stress exerted on the channel region of the MOS transistor of a “basic pattern”. It should be noted that the “basic pattern” refers to a layout pattern which satisfies following requirements (refer to FIG. 4):

(1) The active region 31 is rectangular;

(2) The gate 32 is positioned at the center of the active region 31 (i.e. SA=SB);

(3) The distances PDX1 and PDX2 from the active region 31 to adjacent active regions thereof in the gate-length direction (i.e. active regions 35 and 36) are constant and PDX1=PDX2 (=PDX); and

(4) The distances PDY1 and PDY2 from the active region 31 to adjacent active regions thereof in the gate-width direction (i.e. active regions 33 and 34) are constant and PDY1=PDY2 (=PDY).

As described later, the stress exerted on the channel region of the MOS transistor of the basic pattern is directly calculated by the stress model equations, and the parameter correction amounts are calculated from the calculated stress. On the other hand, the parameter correction amounts for the MOS transistors of layout patterns different from the basic pattern are calculated as a weighted sum of the parameter correction amounts of the MOS transistors of the basic pattern.

The following is a description of the stress model equations for the basic pattern.

Different stress model equations are used between the following two cases:

(1) a case where the SPICE circuit simulation handles both of or none of LOD dependence and W dependence in the MOS transistor characteristics; and

(2) a case where the SPICE circuit simulation handles only one of the LOD dependence and the W dependence in the MOS transistor characteristics.

In the case where the both of the LOD dependence and the W dependence in the MOS transistor characteristics are handled in the SPICE circuit simulation, the transistor model parameters extracted for circuit simulation are defined as having the LOD dependence and the W dependence. In the case where none of the LOD dependence and the W dependence is handled in the SPICE circuit simulation, the transistor model parameters are determined so as to exhibit none of the LOD dependence and the W dependence. Finally, in the case where only one of the LOD dependence and the W dependence in the MOS transistor characteristics is handed in the SPICE circuit simulation, the transistor model parameters extracted for circuit simulation are determined to have only the LOD dependence without having the W dependence, or to have only the W dependence without having the LOD dependence.

3-1. Case where SPICE Circuit Simulation Handles Both of or None of LOD Dependence and W Dependence in MOS Transistor Characteristics

The stress model equations can be obtained by genuinely considering physical and mechanical properties of the active region and the STI dielectric film in the case where the SPICE circuit simulation handles both of or none of LOD dependence and the W dependence in the MOS transistor characteristics (also refer to the following discussion in the section 3-2).

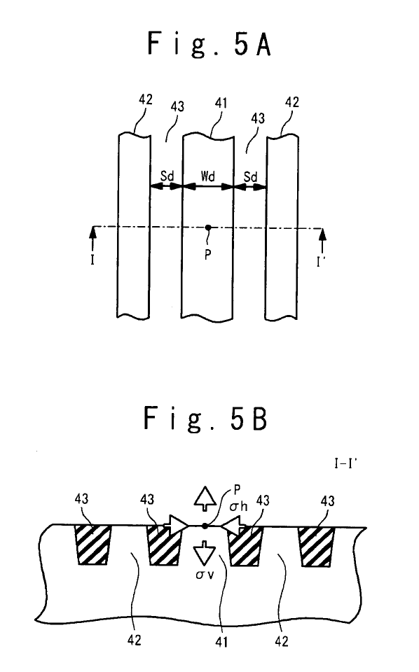

The inventor has initially studied a case where a subject active region 41, an adjacent active region 42 and an STI dielectric film 43 are formed to be sufficiently long in a certain direction, and derived model equations which express the stress which the STI dielectric film 43 exerts on the subject active region 41, as shown in FIGS. 5A and 5B. These model equations are referred to as one-dimensional model equations, hereinafter. The inventor has further obtained stress model equations for the basic pattern through expanding the one-dimensional model equations. In the following, a description is given of the derivation of the one-dimensional model equations and the expansion thereof to the stress model equations for the basic pattern. It should be noted that the polarity of the stress is defined negative when the stress is compressive and defined positive when the stress is tensile in the following.

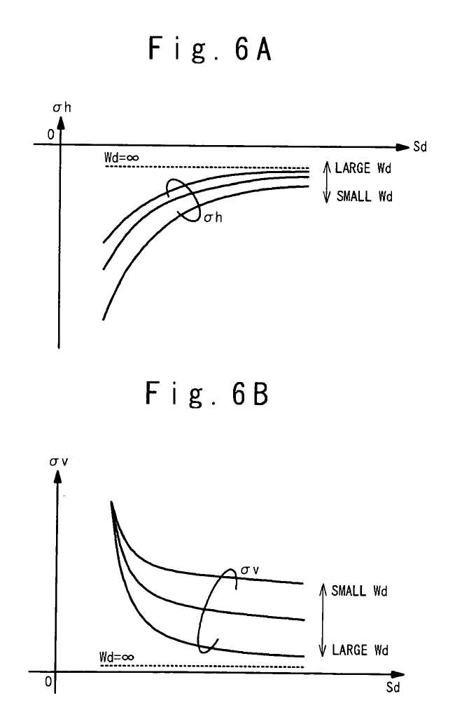

Referring to FIGS. 5A and 5B, the inventor's study has proved that the stress oh exerted in the in-plane direction of the substrate is compressive and the magnitude (or absolute value) of the stress ah increases with the decrease in the distance Sd to the adjacent active regions 42, when the active regions 41 and 42 and the STI dielectric film 43 are formed to be sufficiently long in a certain direction. The magnitude of the stress ah also increases with the decrease in the width Wd of the subject active region 41. In addition, the magnitude of the stress oh converges to a constant value when the distance Sd to the adjacent active region 42 is infinitely large, whereas the magnitude of the stress ah sharply increases with the decrease in the distance Sd, as shown in FIG. 6A. That is, the magnitude of the stress σh monotonously decreases with the increase in the distance Sd, and the magnitude of the differential coefficient dσh/dSd monotonously decreases, converging to 0 when the distance Sd is infinitely large. It should be noted that, due to the fact that the stress oh is compressive stress and the polarity thereof is negative, the value of the stress σh itself monotonously increases with the distance Sd and the differential coefficient dah/dSd takes positive values, monotonously decreasing to converge to 0 when the distance Sd is infinitely large. One of the most simple equations to express such behavior is, for example, the following equation:

$$σ h ( Sd ) = \frac{ha}{Sd + hb} + hc , \qquad ( 1 )$$

where ha, hb and hc are parameters expressing the shape of the curve of the stress σh.

The shape of the curve of the stress σh differs depending on the width Wd of the active region 41. In order to express such difference, parameters ha, hb and hc may be expressed as a function of the width Wd. It should be noted that the function representative of the parameters ha, hb and hc needs to be selected so that the magnitude (or absolute value) of the stress ah monotonously increases with the decrease in the width Wd and the stress σh converges to a constant value when the width Wd is indefinitely large. In this embodiment, the parameters ha, hb and hc are defined by equations similar to the equation 1.

$$\begin{matrix}ha ( Wd ) = \frac{haa}{Wd + hab} + hac , & ( 2 ) \text{-} 1 \\ hb ( Wd ) = \frac{hba}{Wd + hbb} + hbc , & ( 2 ) \text{-} 2 \\ hc ( Wd ) = \frac{hca}{Wd + hcb} + hcc , & ( 2 ) \text{-} 3\end{matrix}$$

In summary, the stress ah exerted in the in-plane direction of the substrate can be expressed by the following equation:

$$σ h ( Wd , Sd ) = \frac{\frac{haa}{Wd + hab} + hac}{Sd + ( \frac{hba}{Wd + hbc} + hbc )} + ( \frac{hca}{Wd + hcb} + hcc ) . \qquad ( 3 ) \text{-} 1$$

The stress σv exerted in the vertical direction of the substrate can be derived in the similar way. The stress σv exerted in the vertical direction of the substrate is tensile, and increases with the decrease in the distance Sd to the adjacent active region 42. The stress σv also increases with the decrease in the width Wd of the subject active region 41. As shown in FIG. 6B, the magnitude (or absolute value) of the stress σv converges to a constant value when the distance Sd to the adjacent active region 42 is infinitely large, whereas the magnitude of the stress σv sharply increases with the decrease in the distance Sd. That is, the magnitude of the stress σv monotonously decreases with respect to the distance Sd, while the magnitude of the differential coefficient dσv/dSd monotonously decreases and converges to 0 when the distance Sd is infinitely large. It should be noted that, due to the fact that the stress σv is tensile and takes positive values, the stress σv itself monotonously decreases with the distance Sd, and the differential coefficient dσv/dSd takes negative values, monotonously increasing and converging to 0 when the distance Sd is infinitely large. Moreover, the magnitude (or absolute value) of the stress σv increases with the decrease in the width Wd becomes smaller, and the stress σv converges to a constant value when the width Wd is infinite. One of equations which satisfy such requirements is the following equation (3)-2:

$$σ v ( Wd , Sd ) = \frac{\frac{vaa}{Wd + vab} + vac}{Sd + ( \frac{vba}{Wd + vbc} + vbc )} + ( \frac{vca}{Wd + vcb} + vcc ) . \qquad ( 3 ) \text{-} 2$$

The equations (3)-1 and (3)-2 are one-dimensional model equations to be obtained. The number of undetermined parameters included in the one-dimensional model equations is 18 in total.

The stress model equations for the basic pattern can be obtained by expanding the one-dimensional model equations, that is, the equations (3)-1 and (3)-2. First, the stress exerted in the in-plane direction of the substrate can be obtained by independently applying the one-dimensional model equations to the gate-length direction (i.e. X direction) and the gate-width direction (i.e. Y direction). That is, the stress σx exerted in the gate-length direction is obtained by the following equation:

σx=σh(LOD,PDX), (4)-1

and the stress σy exerted in the gate-width direction can be obtained by the following equation:

σy=σh(W,PDY), (4)-2

where σh is the function defined by the equation (3)-1.

In addition, the stress oz exerted in the vertical direction of the substrate can be calculated as the sum of the stress exerted on the active region 31 in the vertical direction by the STI dielectric film which separates the active region 31 from the active regions 35 and 36, and the stress exerted on the active region 31 in the vertical direction by the STI dielectric film which separates the active region 31 from the active regions 33 and 34. More specifically, the stress oz exerted in the vertical direction of the substrate can be obtained by the following equation:

σz=σv(LOD,PDX)+σv(W,PDY), (4)-3

where σv is the function defined by the equation (3)-2. The equations (4)-1 to (4)-3 are stress model equations to be obtained for the basic pattern.

Since the equations (4)-1 to (4)-3 are determined by σh and σv, which are determined by the equations (3)-1 and (3)-2, the determination of the equations (4)-1 to (4)-3 requires determining 18 parameters included in the equations (3)-1 and (3)-2. When the SPICE circuit simulation handles both of or none of the LOD dependence and the W dependence in MOS transistor characteristics, these 18 parameters are employed as the stress model parameters.

3-2. Case where SPICE Simulation Handles Only One of LOD Dependence and W Dependence in MOS Transistor Characteristics:

One issue in the SPICE circuit simulation in which only one of the LOD dependence and the W dependence in the MOS transistor characteristics is handled is that the stresses exerted in the gate-length direction the gate-width direction are to be handled differently. When only the LOD dependence is considered in the SPICE circuit simulation, for example, transistor model parameters are extracted in view of effects of the stress exerted in the gate-length direction on the MOS transistor characteristics, wherein the effects of the stress exerted in the gate-width direction on the MOS transistor characteristics are not considered. The same applies to the case where only W dependence is considered in the SPICE circuit simulation.

In order to address this issue, the stress model parameters included in the one-dimensional model equations are defined differently for the gate-length direction (i.e. X direction) and the gate-width direction (i.e. Y direction). That is, the one-dimensional model equations are defined as the following equations (3)-1′, (3)-2′, (3)-1″ and (3)-2″:

$$\begin{matrix}σ hx ( Wd , Sd ) = \frac{\frac{haax}{Wd + habx} + hacx}{Sd + ( \frac{hbax}{Wd + hbcx} + hbcx )} + ( \frac{hcax}{Wd + hcbx} + hccx ) , & ( 3 ) \text{-} {1}^{′} \\ σ vx ( Wd , Sd ) = \frac{\frac{vaax}{Wd + vabx} + vacx}{Sd + ( \frac{vbax}{Wd + vbcx} + vbcx )} + ( \frac{vcax}{Wd + vcbx} + vccx ) , & ( 3 ) \text{-} {2}^{′} \\ σ hy ( Wd , Sd ) = \frac{\frac{haay}{Wd + haby} + hacy}{Sd + ( \frac{hbay}{Wd + hbcy} + hbcy )} + ( \frac{hcay}{Wd + hcby} + hccy ) , & ( 3 ) \text{-} {1}^{″} \\ σ vy ( Wd , Sd ) = \frac{\frac{vaay}{Wd + vaby} + vacy}{Sd + ( \frac{vbay}{Wd + vbcy} + vbcy )} + ( \frac{vcay}{Wd + vcby} + vccy ) , & ( 3 ) \text{-} {2}^{″}\end{matrix}$$

The number of model parameters included in the one-dimensional model equations defined by the equations (3)-1′, (3)-2′, (3)-1″ and (3)-2″ are 36 in total.

In this case, the stress model equations for the basic pattern are defined as the following equations:

σx=σhx(LOD,PDX), (4)-1

σy=σhy(W,PDY), and (4)-2′

σz=σvx(LOD,PDX)+σvy(W,PDY). (4)-3′

Since the equations (4)-1′ to (4)-3′ are determined by σhx, σvx and σvy, which are defined by the equations (3)-1′, (3)-2′, (3)-1″ and (3)-2″, the determination of the equations (4)-1 to (4)-3 requires determining the 36 parameters included in the equations (3)-1′, (3)-2′, (3)-1″ and (3)-2″. When the SPICE circuit simulation handles only one of the LOD dependence and the W dependence in the MOS transistor characteristics, these 36 parameters are employed as the stress model parameters.

### 4. Arithmetic Equations for Calculating Parameter Correction Amounts for MOS Transistor of Basic Pattern

With respect to the MOS transistor of the basic pattern, the parameter correction amounts Δμ and Δν, which are associated with the transistor model parameters U0 and VTH0, can be calculated by using the stresses σx, σy and σz defined by the equations (4)-1 to (4)-3 as follows:

Δμ/μ0=−{πμx(L)·σx+πμy(L)·σy+πμz(L)·σz}, and (5)-1

Δν=−{πνx(L)·σx+πνy(L)·σy+πνz(L)·σz}, (5)-2

where πμx(L), πμy(L) and πμz(L) are parameters expressing degrees of contribution of the stress σx, σy and σz to Δμ/μ0, respectively, while πνx(L), πμy(L) and πνz(L) are parameters expressing degrees of contribution of the stress σx, σy and σz to Δν, respectively. These parameters are defined as the aforementioned sensitivity parameters. It should be noted that the sensitivity parameters πμx(L), πμy(L) and πμz(L), which are related to the mobility correction amounts Δμ/μ0, are consistent with piezoresistance coefficients, which are well known in the art. The sensitivity parameters πμx(L), πμy(L), πμz(L), πνx(L), πνy(L) and πνz(L) are all dependent on the gate length L. In one embodiment, πμx(L), πμy(L), πμz(L), πνx(L), πνy(L) and πνz(L) are defined as a lookup table in which the values thereof are described for respective different gate lengths L. In this case, the number N of sensitivity parameters to be defined is expressed as follows:

N=3 (for X, Y and Z directions)×2 (for Δμ and Δν)×2 (for Nch and Pch)×n,

where n is the number of the gate lengths L described in the lookup table.

The sensitivity parameters πμx(L), πμy(L), πμz(L), πνx(L), πνy(L) and πνz(L) may be defined as an equation dependent on the gate length L. In this case, equations which define πμx(L), πμy(L), πμz(L), πνx(L), πνy(L) and πνz(L) may be obtained by preparing an equation which include underdetermined parameters and determining the underdetermined parameters by data fitting.

It will be understood from the above discussion that the parameter correction amounts for the transistor model parameters U0 and VTH0 of the MOS transistor of the basic pattern are obtained from the functions MULU0F and DELVT0F defined by the following equations (6)-1 and (6)-2:

$$\begin{matrix}MULU 0 F ( L , W , LOD , PDX and PDY ) = 1 + Δμ 0 / μ 0 , \\ = 1 - \{ π μ x ( L ) \cdot σ x + π μ y ( L ) \cdot σ y + πμ z ( L ) \cdot σ z \} , & ( 6 ) \text{-} 1 \\ DELVT 0 F ( L , W , LOD , PDX and PDY ) = Δ ν , and \\ = - \{ πν x ( L ) \cdot σ x + π ν y ( L ) \cdot σ y + πν z ( L ) \cdot σ z \} , & ( 6 ) \text{-} 2\end{matrix}$$

It should be noted that Δμ0/μ0 and Δν, which are defined by the equations (5)-1 and (5)-2, are both functions of L, W, LOD, PDX and PDY.

### 5. Extraction of Stress Model Parameters and Sensitivity Parameters

Before calculating the parameter correction amounts on the basis of the above equations (6)-1 and (6)-2, the stress model parameters and the sensitivity parameters included in the equations (6)-1 and (6)-2 are determined. In this embodiment, the stress model parameters and sensitivity parameters are determined through measuring characteristics of MOS transistors for various layout dimensions, and performing data fitting based on the measurement data obtained by the measurement.

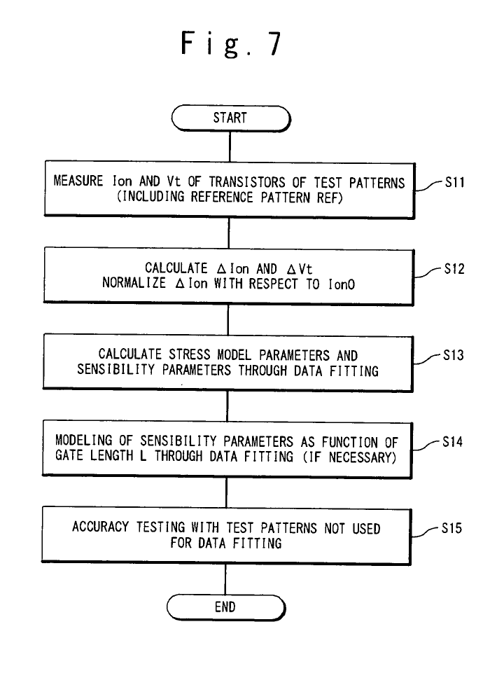

FIG. 7 is a flowchart showing procedures to extract a stress model parameter. First, on-currents Ion and threshold voltages Vt are measured for the MOS transistors of various test patterns to thereby obtain the test pattern measurement data 14 at Step S11. It should be noted that the test patterns refer to the layout patterns with various layout dimensions which are defined to satisfy requirements of the above basic pattern. One of the test patterns is defined as a reference pattern. The reference pattern is a pattern which satisfies the requirements of the above basic pattern and has specific L, W, LOD, PDX and PDY. Preferably, the reference pattern is defined as being identical to the SPICE extraction pattern (i.e. a layout pattern of MOS transistors used for extraction of the transistor model parameters 17).

This is followed by calculation of the difference ΔIon and ΔVt for the respective test patterns other than the reference pattern at Step S12, where ΔIon is the difference between the on-current Ion of the MOS transistor of the test pattern of interest and the on-current Ion0 of the MOS transistor of the reference pattern. Further, the difference ΔIon is normalized by the on-current Ion0 of the MOS transistor of the reference pattern.

Following next is determination of the stress model parameters and sensitivity parameters through data fitting at Step S13. Data fitting at the step S13 is carried out by the solver 5. The test pattern layout data 13 are generated to incorporate the layout dimensions of the respective test patterns to be used for data fitting and supplied to the solver 5.

Data fitting at Step S13 is carried out on an assumption that ΔIon/Ion0 and ΔVt are obtained from the following equations:

ΔIon/Ion0=−{πix(L)·σx+πiy(L)·σy+πiz(L)·σz}, (8)-1

ΔVt=−{πνx(L)·σx+πvy(L)·σy+πvz(L)·σz}, (8)-2

where πix(L), πiy(L) and πiz(L) are sensitivity parameters expressing degrees of contribution of the stress σx, σy and σz to ΔIon/Ion0, while πνx(L), πvy(L) and πvz(L) are sensitivity parameters expressing degrees of contribution of the stress σx, σy and σz to ΔVt. This data fitting achieves determination of the 18 stress model parameters included in the equations (3)-1 and (3)-2 or the 36 stress model parameters included in the equations (3)-1′, (3)-2′, (3)-1″ and (3)-2″, and determination of the sensitivity parameters πix(L), πiy(L), πiz(L), πvx(L), πvy(L) and πvz(L).

It should be noted that the equations (5)-1 and (5)-2 are not used in the above-described determination of stress model parameters through the data fitting. This aims at improving the accuracy of obtained stress model parameters and sensitivity parameters through direct data fitting to the measured on-current Ion and the threshold voltage Vt.

It is not necessary to use all of the 18 stress model parameters included in the equations (3)-1 and (3)-2 or the 36 stress model parameters included in the equations (3)-1′, (3)-2′, (3)-1′ and (3)-2″. If it is possible to realize accurate fitting by a combination of a certain set of stress model parameters, the remaining stress model parameters can be left unused (i.e. determined to be 0).

The sensitivity parameters πix (L), πiy (L), πiz (L), πvx (L), πvy (L) and πvz (L) obtained by the above-described data fitting are converted to sensitivity parameters πμx (L), πμy (L), πμz (L), πνx (L), πνy (L) and πνz (L) to be used in the equations (5)-1 and (5)-2. In this conversion, a matrix which expresses a relationship between the variations of Ion and Vt and the variations of μ and ν for each gate length L is determined by using the transistor model parameters used in the SPICE simulation, and the inverse matrix of the determined matrix is used for the conversion of the sensitivity parameters. More specifically, the conversion is carried out by the following equation:

$$( \begin{matrix}πμ x & π μ y & πμ z \\ πν x & πν y & πν z\end{matrix} ) = ( \begin{matrix}\frac{μ}{Ion} \cdot \frac{\partial Ion}{\partial μ} & \frac{1}{Ion} \cdot \frac{\partial Ion}{\partial μ} \\ μ \cdot \frac{\partial Vt}{\partial μ} & \frac{\partial Vt}{\partial v}\end{matrix} ) \cdot ( \begin{matrix}π i x & π i y & π i z \\ π v x & π v y & π v z\end{matrix} ) , \qquad ( 9 )$$

It should be noted that the conversion of the sensitivity parameters by the equation (9) is implemented for each gate length L. The values of the stress model parameters and sensitivity parameters are thus determined.

In one implementation, the sensitivity parameters πμx(L), πμy(L), πμz(L), πνx(L), πνy(L) and πνz(L) are described in the stress model parameter file 15 as a table in which the values of the sensitivity parameters πμx(L), πμy(L), πμz(L), πνx(L), πνy(L) and πνz(L) are written for each gate length L.

If necessary, a process is carried out so that the sensitivity parameters πμx(L), πμy(L), πμz(L), πνx(L), πνy(L) and πνz(L) obtained at the step S13 are modeled into model equations by data fitting at Step S14. In this case, the sensitivity parameters πμx(L), πμy(L), πμz(L), πνx(L), πνy(L) and πνz(L) are described in the stress model parameter file 15 as model equations which include the gate length L as a variable. The model equations may be obtained by defining equations which include undetermined parameters and determining the parameters by data fitting. For example, the following equations (10)-1 to (10)-6 may be used to define πμx(L), πμy(L), πμz(L) πνx(L), πνy(L) and πνz(L)

$$\begin{matrix}π μ x ( L ) = \frac{h a μ x}{L + hb μ x} + hc μ x , & ( 10 ) \text{-} 1 \\ π μ y ( L ) = \frac{h a μ y}{L + hb μ y} + hc μ y , & ( 10 ) \text{-} 2 \\ π μ z ( L ) = \frac{h a μ z}{L + hb μ z} + hc μ z , & ( 10 ) \text{-} 3 \\ π ν x ( L ) = \frac{h a ν x}{L + hb ν x} + hc ν x , & ( 10 ) \text{-} 4 \\ π ν y ( L ) = \frac{h a ν y}{L + hb ν y} + hc ν y , & ( 10 ) \text{-} 5 \\ π ν z ( L ) = \frac{h a ν z}{L + hb ν z} + hc ν z , & ( 10 ) \text{-} 6\end{matrix}$$

In this case, the following 12 parameters are determined by data fitting: haμx, haμy, haμz, hbμx, hbμy, hbμz, hcμx, hcμy, hcμz, haνvx, haνy, haνz, hbνx, hbνy, hbνz, hcνx, hcνy and hcνz.

Following next is accuracy testing of the stress model parameters and the sensitivity parameters obtained by the data fitting at Step S15. More specifically, the parameter correction amounts calculated by the stress model equations for the basic pattern and the equations (5)-1 and (5)-2 from the layout dimensions (L, W, LOD, PDX and PDY) of the MOS transistors of the test patterns which are not used for data fitting are compared with the parameter correction amounts calculated from measured values of characteristics of the MOS transistors of the test patterns. The comparison result is used to determine whether or not the stress model parameter and the sensitivity parameter are appropriately determined.

The above procedure determines the functions MULU0F and DELVT0F for calculating the parameter correction amounts for the basic pattern. When the functions MULU0F and DELVT0F are called with L, W, LOD, PDX and PDY used as arguments, the calculation based on the equations (6)-1 and (6)-2 are implemented and the calculation results are returned.

It should be noted that inaccurate results may be obtained by the above-described functions MULU0F and DELVT0F, when the reference pattern differs from the SPICE extraction pattern. This is because the SPICE circuit simulation requires calculation of the parameter correction amounts with respect to the MOS transistors of the SPICE extraction pattern, which is used for extraction of the transistor model parameters 17.

Therefore, the following functions MULU0F′ and DELVT0F′ are used as functions to calculate the parameter correction amounts for the basic pattern in place of the functions MULU0F and DELVT0F, which are defined by the equations (6)-1 and (6)-2, in the case where the reference pattern differs from the SPICE extraction pattern:

(1) Case where SPICE Circuit Simulation Handles Lod Dependence

MULU0F′(L,W,LOD,PDX,PDY)=MULU0F(L,W,LOD,PDX,PDY)−−MULU0F(L,W,LOD,PDX_{SPC},PDY_{SPC}) and (6)-1′

DELVT0F′(L,W,LOD,PDX,PDY)=DELVT0F(L,W,LOD,PDX,PDY)−DELVT0F(L,W,LOD,PDX_{SPC},PDY_{SPC}). (6)-2′

(2) Case where SPICE Circuit Simulation does not Handle LOD Dependence:

MULU0F′(L,W,LOD,PDX,PDY)=MULU0F(L,W,LOD,PDX,PDY)−MULU0F(L,W,LOD_{SPC},PDX_{SPC},PDY_{SPC}) and (6)-1″

DELVT0F′(L,W,LOD,PDX,PDY)=DELVT0F(L,W,LOD,PDX,PDY)−DELVT0F(L,W,LOD_{SPC},PDX_{SPC},PDY_{SPC}) (6)-2″

In the equations (6)-1′, (6)-2′, (6)-1, (6)-2″, LODSPC, PDXSPC and PDYSPC are LOD, PDX and PDY in the SPICE extraction pattern, respectively.

### 6. Extraction of Parameter Correction Amounts

One issue is that the above-described functions MULU0F and DELVT0F (or MULU0F′ and DELVT0F′) are defined to calculate the parameter correction amounts only for the basic pattern. The length of the active region of the subject MOS transistor and the distances to adjacent active regions are not necessarily constant for a general layout pattern. In other words, the general layout pattern does not always satisfy the requirements of the basic pattern.

In order to address this, the channel region is divided into a plurality of channel portions for each MOS transistor, and the functions MULU0F and DELVT0F (or MULU0F′ and DELVT0F′) are applied to each channel portion. The parameter correction amounts for the subject MOS transistor as a whole are calculated as a weighted sum of parameter correction amounts calculated by applying the functions MULU0F and DELVT0F (or MULU0F′ and DELVT0F′) to the respective channel portions.

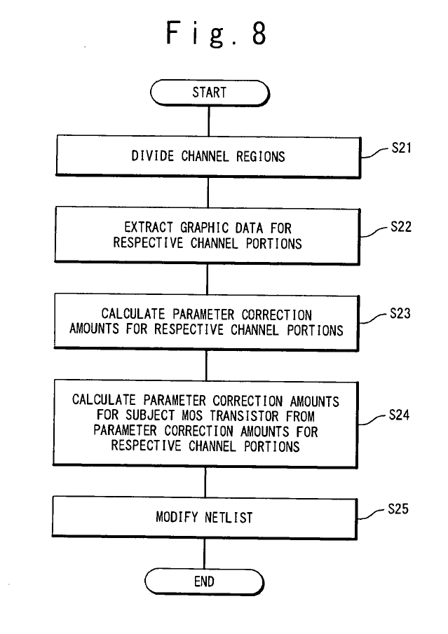

FIG. 8 is a flowchart showing procedures for calculating the parameter correction amounts for the subject MOS transistor in this embodiment.

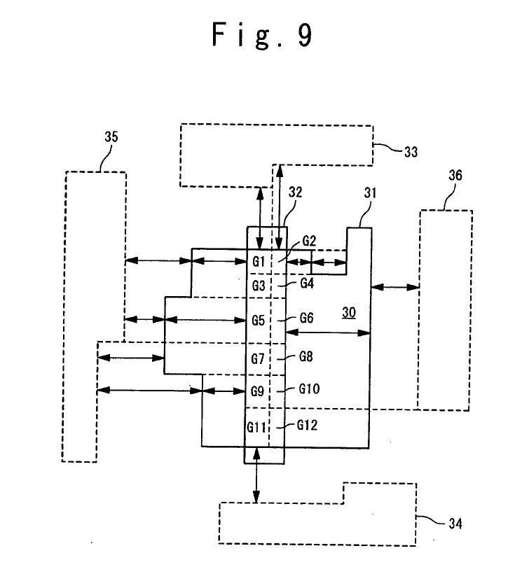

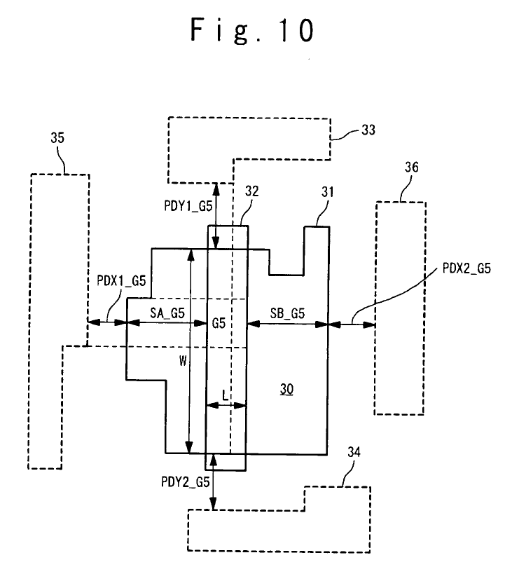

First, as shown in FIG. 9, the channel region of the subject transistor 30 is divided into a plurality of channel portions at Step S21. In the example of FIG. 9, the channel region is divided into 12 channel portions G1 to G12. The channel region is divided at the positions of the projections from the respective changing points of 1) the distance from the channel region to the edges of the active region 31 in the gate-length direction; 2) the distance from the active region 31 of the subject MOS transistor 30 to the adjacent active regions 33 and 34; and 3) the distance from the active region 31 of the subject MOS transistor 30 to the adjacent active regions 35 and 36.

This is followed by extraction of graphic data from the layout data 12 for each channel portion at Step S22. More specifically, extracted for each channel portion are:

1) the distances SA and SB between the gate to the edges of the active region 31 in the subject MOS transistor 30; and
2) the widths PDX1, PDX2, PDY1 and PDY2 of the STI dielectric film which separates the active region 31 from the adjacent active regions.

It should be noted that the distances SA and SB from the gate to the edges of the active region 31 which are extracted for channel portions Gi are referred to as SA_G₁ and SB_Gi, respectively. Similarly, the widths PDX1, PDX2, PDY1 and PDY2 of the STI dielectric film which are extracted for the channel portions Gi are referred to as PDX1_Gi, PDX2_Gi, PDY1_Gi and PDY2_Gi, respectively.

Furthermore, LOD1_Gi and LOD2_Gi are defined for each channel portions Gi by the following equations:

LOD1_{—}Gi=2·SA_{—}Gi+L, and (11)-1

LOD2_{—}Gi=2·SB_{—}Gi+L, (11)-2

LOD1_Gi and LOD2_Gi are physical quantities corresponding to the length LOD of the active region 31 in the gate-length direction, and introduced to consider asymmetry in the gate position in the gate-length direction.

Following next is calculation of parameter correction amounts MULU0_Gi and DELVT0_Gi for each channel portion Gi at Step S23.

When the reference pattern is same as the SPICE extraction pattern, the parameter correction amounts MULU0_Gi and DELVT0_Gi are calculated by the following equations using the functions MULU0F and DELVT0F:

$$\begin{matrix}\begin{matrix}MULU0\_Gi = {\sum }_{s , t , u = 1 , 2 } \{ MULU 0 F ( L , W , LODs\_Gi , \\ PDXt\_Gi , PDYu\_Gi ) \} / 8 , \\ = \{ MULU 0 F ( L , W , LOD1\_Gi , PDX1\_Gi , \\ PDY1\_Gi ) + MULU 0 F ( L , W , LOD1\_Gi , \\ PDX1\_Gi , PDY2\_Gi ) + MULU 0 F ( L , \\ W , LOD1\_Gi , PDX2\_Gi , PDY1\_Gi ) + \\ MULU 0 F ( ( L , W , LOD1\_Gi , PDX2\_Gi , \\ PDY2\_Gi ) + MULU 0 F ( L , W , LOD2\_Gi , \\ PDX1\_Gi , PDY1\_Gi ) + MULU 0 F ( L , \\ W , LOD2\_Gi , PDX1\_Gi , PDY2\_Gi ) + \\ MULU 0 F ( L , W , LOD2\_Gi , PDX2\_Gi , \\ PDY1\_Gi ) + MULU 0 F ( L , W , LOD2\_Gi , \\ PDX2\_Gi , PDY2\_Gi ) \} / 8 ,\end{matrix} & ( 12 ) \text{-} 1 \\ \begin{matrix}DELVT0\_Gi = {\sum }_{s , t , u = 1 , 2 } \{ DELVT 0 F ( L , W , LODs\_Gi , \\ PDXt\_Gi , PDYu\_Gi ) \} / 8 , \\ = \{ DELVT 0 F ( L , W , LOD1\_Gi , PDX1\_Gi , \\ PDY1\_Gi ) + DELVT 0 F ( L , W , LOD1\_Gi , \\ PDX1\_Gi , PDY2\_Gi ) + DELVT 0 F ( L , \\ W , LOD1\_Gi , PDX2\_Gi , PDY1\_Gi ) + \\ DELVT 0 F ( L , W , LOD1\_Gi , PDX2\_Gi , \\ PDY2\_Gi ) + DELVT 0 F ( L , W , LOD2\_Gi , \\ PDX1\_Gi , PDY1\_Gi ) + DELVT 0 F ( L , \\ W , LOD2\_Gi , PDX1\_Gi , PDY2\_Gi ) + \\ DELVT 0 F ( L , W , LOD2\_Gi , PDX2\_Gi , \\ PDY1\_Gi ) + DELVT 0 F ( L , W , LOD2\_Gi , \\ PDX2\_Gi , PDY2\_Gi ) \} / 8 ,\end{matrix} & ( 12 ) \text{-} 2\end{matrix}$$

Technical meaning of the equations (12)-1 and (12)-2 is as follows: there are two possible values allowed to be substituted into the functions MULU0F and DELVT0F as each of LOD, PDX and PDY for each channel portions Gi. The parameter correction amounts MULU0_Gi and DELVT0 Gi for each channel portions Gi are obtained as the mean value of parameter correction amounts obtained by using the functions MULU0F and DELVT0F for all the possible combinations of LOD, PDX and PDY.

When the reference pattern differs from the SPICE extraction pattern, calculation similar to that of the equations (12)-1 and (12)-2 is done by using the functions MULU0F′ and DELVT0F′ in place of the functions MULU0F and DELVT0F as follows:

$$\begin{matrix}\begin{matrix}MULU0\_Gi = {\sum }_{s , t , u = 1 , 2 } \{ MULU 0 {F}^{′} ( L , W , LODs\_Gi , \\ PDXt\_Gi , PDYu\_Gi ) \} / 8 , \\ = \{ MULU 0 {F}^{′} ( L , W , LOD1\_Gi , PDX1\_Gi , \\ PDY1\_Gi ) + MULU 0 {F}^{′} ( L , W , LOD1\_Gi , \\ PDX1\_Gi , PDY2\_Gi ) + MULU 0 {F}^{′} ( L , \\ W , LOD1\_Gi , PDX2\_Gi , PDY1\_Gi ) + \\ MULU 0 {F}^{′} ( L , W , LOD1\_Gi , PDX2\_Gi , \\ PDY2\_Gi ) + MULU 0 {F}^{′} ( L , W , LOD2\_Gi , \\ PDX1\_Gi , PDY1\_Gi ) + MULU 0 {F}^{′} ( L , \\ W , LOD2\_Gi , PDX1\_Gi , PDY2\_Gi ) + \\ MULU 0 {F}^{′} ( L , W , LOD2\_Gi , PDX2\_Gi , \\ PDY1\_Gi ) + MULU 0 {F}^{′} ( L , W , LOD2\_Gi , \\ PDX2\_Gi , PDY2\_Gi ) \} / 8 ,\end{matrix} & ( 12 ) \text{-} {1}^{′} \\ \begin{matrix}DELVT0\_Gi = {\sum }_{s , t , u = 1 , 2 } \{ DELVT 0 {F}^{′} ( L , W , LODs\_Gi , \\ PDXt\_Gi , PDYu\_Gi ) \} / 8 , \\ = \{ DELVT 0 {F}^{′} ( L , W , LOD1\_Gi , PDX1\_Gi , \\ PDY1\_Gi ) + DELVT 0 {F}^{′} ( L , W , LOD1\_Gi , \\ PDX1\_Gi , PDY2\_Gi ) + DELVT 0 {F}^{′} ( L , \\ W , LOD1\_Gi , PDX2\_Gi , PDY1\_Gi ) + \\ DELVT 0 {F}^{′} ( L , W , LOD1\_Gi , PDX2\_Gi , \\ PDY2\_Gi ) + DELVT 0 {F}^{′} ( L , W , LOD2\_Gi , \\ PDX1\_Gi , PDY1\_Gi ) + DELVT 0 {F}^{′} ( L , \\ W , LOD2\_Gi , PDX1\_Gi , PDY2\_Gi ) + \\ DELVT 0 {F}^{′} ( L , W , LOD2\_Gi , PDX2\_Gi , \\ PDY1\_Gi ) + DELVT 0 {F}^{′} ( L , W , LOD2\_Gi , \\ PDX2\_Gi , PDY2\_Gi ) \} / 8 ,\end{matrix} & ( 12 ) \text{-} {2}^{′}\end{matrix}$$

Following next is calculation of the parameter correction amounts of the subject MOS transistor 30 from the parameter correction amounts MULU0_Gi and DELVT0_Gi, which are calculated for each channel portion Gi (Step S24). The parameter correction amounts MULU0 and DELVT0 of the subject transistor 30 are respectively calculated as weighted sums of the parameter correction amounts MULU0_Gi and DELVT0_Gi, which are calculated for the respective channel portions Gi. More specifically, the parameter correction amounts MULU0 and DELVT0 of the subject transistor 30 are calculated by using the following equations (13)-1 and (13)-2:

$$\begin{matrix}\begin{matrix}MULU 0 = {\sum }_{i} MULU0\_Gi \cdot Si / ( L \cdot W ) , \\ = MULU0\_G 1 \cdot S 1 / ( L \cdot W ) + \\ MULU0\_G2 \cdot S 2 / ( L \cdot W ) … + \\ MULU0\_G12 \cdot S 12 / ( L \cdot W ) ,\end{matrix} & ( 13 ) \text{-} 1 \\ \begin{matrix}DELVT 0 = {\sum }_{i} DELVT0\_Gi \cdot Si / ( L \cdot W ) , \\ = DELVT0\_G 1 \cdot S 1 / ( L \cdot W ) + \\ DELVT0\_G2 \cdot S 2 / ( L \cdot W ) … + \\ DELVT0\_G12 \cdot S 12 / ( L \cdot W ) .\end{matrix} & ( 13 ) \text{-} 2\end{matrix}$$

where the weighting coefficients are determined on the basis of the areas Si of the respective channel portions Gi.

The parameter correction amounts MULU0 and DELVT0 calculated for each MOS transistor are additionally described in the netlist at Step S25. That is, the calculated parameter correction amounts MULU0 and DELVT0 are added to the netlist 11, whereby the modified netlist 16 is produced. As stated above, the parameter correction amounts 20 written in the modified netlist 16 is used to correct the transistor model parameters 17 prepared for the SPICE extraction pattern to obtain the transistor model parameters to be actually used for circuit simulation.

It is preferable to check the magnitudes of the parameter correction amounts MULU0 and DELVT0 before the parameter correction amounts MULU0 and DELVT0 calculated for each MOS transistor are described in the netlist. An excessively large magnitude (or absolute value) of the parameter modulation value MULU0 or DELVT0 implies the existence of miscalculation. It is preferable to output a warning from the LVS tool 3 when the calculated parameter correction amounts MULU0 and/or DELVT0 are out of a predetermined range.

Referring back to FIG. 2, it is also preferable that the layout editor 2 has a function to read the modified netlist 16. In this case, the layout editor 2 is desirably programmed to display the calculated parameter correction amounts MULU0 and DELVT0 in the vicinity of the corresponding MOS transistor on the display screen. In addition to or in place of the parameter correction amounts MULU0 and DELVT0, the on-current variation ΔIon and the threshold voltage variation ΔVt, which are calculated from the parameter modulation values MULU0 and DELVT0, may be displayed on the display screen.

Similarly, it is also preferable that the circuit diagram editor 1 has a function to read the modified netlist 16. In this case, the circuit diagram editor 1 is desirably programmed to display the calculated parameter correction amounts MULU0 and DELVT0 in the vicinity of the corresponding MOS transistor on the display screen. In addition to or in place of the parameter correction amounts MULU0 and DELVT0, the on-current variation ΔIon and the threshold voltage variation ΔVt, which are calculated from the parameter correction amounts MULU0 and DELVT0, may also be displayed.

Although various specific embodiments of the present invention are described above, the present invention should not be interpreted as being limited to the above-described embodiments. For example, although the parameter correction amounts MULU0 and DELVT0 are calculated to correct the transistor model parameters U0 and VTH0 in the above-described embodiments, a similar method can be applied to calculate other parameter correction amounts for correction of other transistor model parameters. Correction of an increased number of transistor model parameters on the basis of the stress is preferable to improve the accuracy of circuit simulation.

What is claimed is:

1. A circuit simulation method comprising:
generating graphical data indicating dimensions of a subject MOS transistor;
calculating a parameter correction amount based on said graphical data;
correcting a given transistor model parameter in response to said parameter correction amount; and
performing circuit simulation of a circuit that includes said subject MOS transistor by using said corrected transistor model parameter,
wherein said parameter correction amount is calculated based on said graphical data by using arithmetic equations,
wherein said arithmetic equations include at least one stress model equation expressing a stress exerted on a channel region of a model MOS transistor,
wherein said stress model equation is defined so that a magnitude of said stress monotonously decreases with an increase in an adjacent distance from an active region within which said channel region of said model MOS transistor is formed to an active region adjacent thereto, and converges to a constant value when said adjacent distance is infinitely large, and so that an absolute value of a differential coefficient of said stress with respect to said adjacent distance monotonously decreases with an increase in said adjacent distance, and converges to zero when said adjacent distance is infinitely large.

2. The circuit simulation method according to claim 1, wherein said stress model equation is defined so that a dependency of said magnitude of said stress on said adjacent distance varies in response to a width of said active region within which said channel region is formed.

3. The circuit simulation method according to claim 2, wherein said stress model equation is defined so that said magnitude of said stress monotonously decreases with an increase in said width of said active region within which said channel region is formed, and converges to a constant value when said width of said active region within which said channel region is formed is infinitely large.

4. The circuit simulation method according to claim 1, wherein said at least one stress model equation includes an equation representing a stress exerted in an in-plane direction of a substrate, and an equation representing a stress exerted in a vertical direction of said substrate.

5. The circuit simulation method according to claim 4, wherein said stress model equation represents said stress of said channel region of said model MOS transistor for a case where a layout pattern of said model MOS transistor is a basic pattern in which said active region is rectangular and has a length of LOD in a gate-length direction and a width of W, a gate is positioned at a center of said active region, distances PDX from said active region to active regions adjacent thereto in the gate-length direction are same and constant, and distances PDY from said active region to active regions adjacent thereto in the gate-width direction are same and constant, and
wherein said at least one stress model equation represents a stress σx exerted in a first direction which is an in-plane direction of the substrate, a stress σy exerted in a second direction which is an in-plane direction of the substrate and perpendicular to said first direction, and a stress σz exerted in a third direction which is the vertical direction of the substrate by the following equations:
σx=σh(LOD,PDX),
σy=σh(W,PDX), and
σz=σv(LOD,PDX)+σv(W,PDY),
where σh and σv are functions defined with arguments Wd and Sd as follows:
$$σ h ( Wd , Sd ) = \frac{\frac{haa}{Wd + hab} + hac}{Sd + ( \frac{hba}{Wd + hbc} + hbc )} + ( \frac{hca}{Wd + hcb} + hcc ) , \\ σ v ( Wd , Sd ) = \frac{\frac{vaa}{Wd + vab} + vac}{Sd + ( \frac{vba}{Wd + vbc} + vbc )} + ( \frac{vca}{Wd + vcb} + vcc ) ,$$

6. The circuit simulation method according to claim 4, wherein said stress model equation represents said stress of said channel region of said model MOS transistor for a case where a layout pattern of said model MOS transistor is a basic pattern in which said active region is rectangular and has a length of LOD in a gate-length direction and a width of W, a gate is positioned at a center of said active region, distances PDX from said active region to active regions adjacent thereto in the gate-length direction are same and constant, and distances PDY from said active region to active regions adjacent thereto in the gate-width direction are same and constant, and
wherein said at least one stress model equation represents a stress σx exerted in a first direction which is an in-plane direction of the substrate, a stress σy exerted in a second direction which is an in-plane direction of the substrate and perpendicular to said first direction, and a stress σz exerted in a third direction which is the vertical direction of the substrate by the following equations:
σx=σhx(LOD,PDX),
σy=σhy(W,PDX), and
σz=σvx(LOD,PDX)+σvy(W,PDY),
where σhx, σhy, σvx and σvy are functions defined with arguments Wd and Sd as follows:
$$\begin{matrix}σ hx ( Wd , Sd ) = \frac{\frac{haax}{Wd + habx} + hacx}{Sd + ( \frac{hbax}{Wd + hbcx} + hbcx )} + ( \frac{hcax}{Wd + hcbx} + hccx ) , \\ σ vx ( Wd , Sd ) = \frac{\frac{vaax}{Wd + vabx} + vacx}{Sd + ( \frac{vbax}{Wd + vbcx} + vbcx )} + ( \frac{vcax}{Wd + vcbx} + vccx ) , \\ σ hy ( Wd , Sd ) = \frac{\frac{haay}{Wd + haby} + hacy}{Sd + ( \frac{hbay}{Wd + hbcy} + hbcy )} + ( \frac{hcay}{Wd + hcby} + hccy ) , \\ σ vy ( Wd , Sd ) = \frac{\frac{vaay}{Wd + vaby} + vacy}{Sd + ( \frac{vbay}{Wd + vbcy} + vbcy )} + ( \frac{vcay}{Wd + vcby} + vccy ) ,\end{matrix}$$

7. The circuit simulation method according to claim 1, wherein said calculating said parameter correction amount includes:
dividing a channel region of said subject MOS transistor into a plurality of channel portions based on changes in distances from a gate of said target MOS transistor to edges of an active region of said target MOS transistor; changes in gate-length direction distances which are distances from said active region of said target MOS transistor to first active regions adjacent thereto in a gate-length direction; and
changes in a gate-width direction distance which are distances from said active region of said target MOS transistor to second active regions adjacent thereto in a gate-width direction,
calculating partial parameter correction amounts which are parameter correction amounts defined for said respective channel portions; and
calculating said parameter correction amount from said partial parameter correction amounts.

8. The circuit simulation method according to claim 7, wherein said calculating said partial parameter correction amounts includes:
calculating parameter correction amounts by using a parameter correction amount calculation equation obtained for a case where a layout pattern of said model MOS transistor is a basic pattern in which said active region is rectangular, a gate is positioned at a center of said active region, distances from said active region to active regions adjacent thereto in the gate-length direction are same and constant, and distances from said active region to active regions adjacent thereto in the gate-width direction are same and constant, for said respective channel portions and for respective combinations of distances from said gate of said target MOS transistor to gate-length direction edges of said active region thereof which are positioned in said gate length direction with respect to said channel portions, distances from said first active regions to said gate-length direction edges, and directions from said second active regions to gate-width direction edges of said active region of said target MOS transistor which are positioned in said gate width direction with respect to said channel portions; and
calculating said partial parameter correction amounts through averaging said parameter correction amounts calculated for said respective combinations.

9. The circuit simulation method according to claim 7, wherein said parameter correction amount is calculated as a weighted sum of said partial parameter correction amounts with weighting coefficients determined in accordance with areas of said channel portions.

10. A circuit simulation apparatus comprising:
a tool which generates graphical data indicating dimensions of a subject MOS transistor and calculates a parameter correction amount based on said graphical data; and
a circuit simulator which corrects a given transistor model parameter in response to said parameter correction amount, and performs circuit simulation of a circuit that includes said subject MOS transistor by using said corrected transistor model parameter,
wherein said parameter correction amount is calculated based on said graphical data by using arithmetic equations,
wherein said arithmetic equations include at least one stress model equation expressing a stress exerted on a channel region of a model MOS transistor,
wherein said stress model equation is defined so that a magnitude of said stress monotonously decreases with an increase in an adjacent distance from an active region within which said channel region of said model MOS transistor is formed to an active region adjacent thereto, and converges to a constant value when said adjacent distance is infinitely large, and so that an absolute value of a differential coefficient of said stress with respect to said adjacent distance monotonously decreases with an increase in said adjacent distance, and converges to zero when said adjacent distance is infinitely large.

11. The circuit simulation apparatus according to claim 10, wherein said tool divides a channel region of said subject MOS transistor into a plurality of channel portions based on changes in distances from a gate of said target MOS transistor to edges of an active region of said target MOS transistor; changes in gate-length direction distances which are distances from said active region of said target MOS transistor to first active regions adjacent thereto in a gate-length direction; and changes in a gate-width direction distance which are distances from said active region of said target MOS transistor to second active regions adjacent thereto in a gate-width direction;
wherein said tool calculates partial parameter correction amounts which are parameter correction amounts defined for said respective channel portions; and calculates said parameter correction amount from said partial parameter correction amounts.

12. A computer-readable recording medium which records a program that when executed controls a computer to perform a method comprising:
generating graphical data indicating dimensions of a subject MOS transistor;
calculating a parameter correction amount based on said graphical data;
correcting a given transistor model parameter in response to said parameter correction amount; and
performing circuit simulation of a circuit that includes said subject MOS transistor by using said corrected transistor model parameter,
wherein said parameter correction amount is calculated based on said graphical data by using arithmetic equations,
wherein said arithmetic equations include at least one stress model equation expressing a stress exerted on a channel region of a model MOS transistor,
wherein said stress model equation is defined so that a magnitude of said stress monotonously decreases with an increase in an adjacent distance from an active region within which said channel region of said model MOS transistor is formed to an active region adjacent thereto, and converges to a constant value when said adjacent distance is infinitely large, and so that an absolute value of a differential coefficient of said stress with respect to said adjacent distance monotonously decreases with an increase in said adjacent distance, and converges to zero when said adjacent distance is infinitely large.

13. The computer-readable recording medium according to claim 12, wherein said calculating said parameter correction amount includes:
dividing a channel region of said subject MOS transistor into a plurality of channel portions based on changes in distances from a gate of said target MOS transistor to edges of an active region of said target MOS transistor; changes in gate-length direction distances which are distances from said active region of said target MOS transistor to first active regions adjacent thereto in a gate-length direction; and
changes in a gate-width direction distance which are distances from said active region of said target MOS transistor to second active regions adjacent thereto in a gate-width direction,
calculating partial parameter correction amounts which are parameter correction amounts defined for said respective channel portions; and
calculating said parameter correction amount from said partial parameter correction amounts.
